(19) United States
(12) Patent Application Publication
(10) Pub. No.: US 2017/0113502 A1
(43) Pub. Date: Apr. 27, 2017

(54) COVER FOR COVERING A TOW BALL AND TOW BALL MOUNT

(71) Applicant: Ark Corporation Pty. Ltd., Arndell Park (AU)

(72) Inventors: Richard ARAKELIAN, Arndell Park (AU); Andrew READE, Arndell Park (AU)

(21) Appl. No.: 15/331,215

(22) Filed: Oct. 21, 2016

(30) Foreign Application Priority Data
Oct. 23, 2015 (AU) 2015101577

(51) Int. Cl. B60D 1/60; B60D 1/06

(52) U.S. Cl. CPC B60D 1/605; B60D 1/06

(57) ABSTRACT

A unitary tow ball and tow ball mount cover is described. The cover includes a hollow base portion configured to cover a tow ball mount and a hollow head portion configured to cover a tow ball, wherein the hollow base portion and the hollow head portion form a junction at atop of the base portion and afoot of the head portion to form a unitary cover.

### TECHNICAL FIELD

The present invention relates generally to a cover for covering a tow ball and tow ball mount.

### BACKGROUND

Deterioration of towballs can occur because of, among other things, rust and wear. Towball covers are used to inhibit deterioration of the towball, so as to help maintain its outer dimensions within tightly-set tolerances. Any change in outer dimensions reduces the ability of the towball to retain a towing coupling.

Tow ball covers usually comprise a hollow, domed cylindrical housing, open at a base end, with a leaf-spring retainer deep inside the cylinder to hold the tow ball cover onto the tow ball. A portion of the leaf spring generally cribs an underside of the tow ball to resist removal of the cylinder. The tow ball cover has been the subject of cost-cutting and competitive pressures over the years and now takes a generally flimsy form, which can crack along the cylinder wall after brief exposures to UV and/or light forces.

In addition, the tow ball cover, once it is cracked, has reduced retention strength and often falls off without the owner noticing, then leading to greater likelihood of tow ball rusting, with the associated change in tow ball dimension.

Known tow ball covers can mark and wear towballs with their leaf winds during on-off cycles. Furthermore, the cylindrical towball cover is able to rotate on the tow ball, and the spring then wears the towball.

Tow balls are generally mounted atop tow ball mounts. Tow ball mount covers are also known to be used to protect the tow ball mount. These tow ball mount covers are provided to reduce shin injuries and to reduce rusting of the tow ball mount. Even so, water seems to get into cracks between tow ball base and the tow ball mount cover, even when the tow ball cover is present on the tow ball. Rust of the tow ball base and tow ball mount is the result.

Another source of injury is a laceration from sliding or bumping contact with a towball mount and/or a threaded tow ball shank, which extends below the tow ball mount.

It is also important to maintain an aesthetic appearance to the rear of the vehicle, for example, by covering a rusty towball and/or towball mount.

The present inventor seeks to provide a new tow ball cover. The new tow ball cover seeks to ameliorate one or more of the abovementoned disadvantages.

Throughout this specification and the claims that follow, the orientation of the tow ball and tow ball mount cover is to be taken to reflect that of a towing vehicle to which it is attached in the installed position. That is, a rear face or wall is a face or wall that faces traffic behind the towing vehicle. A front face or wall would be one which faces the direction of travel of the towing vehicle, and is one which, when the tow ball cover is in an installed position, would be adjacent a rear face of the towing vehicle.

### SUMMARY

Broadly, the technology provides a unitary tow ball and tow ball mount cover. The tow ball and low ball mount cover includes a hollow base portion configured to cover a tow ball mount and a hollow head portion configured to cover a tow ball, wherein the hollow base portion and the hollow head portion are connected at a junction at a top of the base portion and a foot of the head portion to form a unitary cover.

In accordance with a first aspect of the present technology there is provided a tow ball cover including:
a base portion configured to cover a tow ball mount, the base portion comprising a deck and a skirt depending therefrom;
a head portion configured to cover a tow ball, the head portion comprising a tow ball receiving housing, being open at a foot end;
wherein the base portion and the head portion are connected at a junction between the deck and the foot end of the head portion.

In one embodiment the deck includes a beveled edge extending around the skirt for increasing strength of the deck edge and reducing impact damage in the event of shin contact. Advantageously, the beveled edge also reduces stress concentrations for resistance to breakage when the skirt is bumped.

In one embodiment the skirt includes a plurality of skirt wails generally opposed to one another to generally follow the contour of the tow ball mount. In one embodiment there are provided three skirt walls, each one integrally connected to adjacent ones around the deck. In one embodiment a rearward-facing wall is provided, which is generally flat to provide a surface on which advertising messages or brand names may be placed for easy viewing from a following vehicle.

In one embodiment the skirt includes a bumper disposed proud of each of the skirt wall which is configured to cushion any impact from, say, a shin. In one embodiment the bumper is a different material from the base portion. In one embodiment the bumper is silicon rubber but could be another impact-reducing material such as rubberised polymer or other kinds of rubber. In one embodiment the bumper has voids so as to increase elasticity and to reduce impacts.

The bumper may be integral with the skirt or in one embodiment, the bumper is a separate bumper element attached to the skirt. In one embodiment the bumper is configured to mount on respective bumper mounts disposed on the skirt walls.

In one embodiment the bumper mounts include a bumper mount stem and a bumper mount head disposed at an end of the bumper mount stem. In one embodiment the bumper includes a plurality of cooperating bumper mount receivers for receiving the bumper mounts. In one embodiment the bumper mount receivers are voids disposed in a base and/or inside wall of the bumper.

In one embodiment one or more of the skirt walls extend below the tow ball mount so as to protect a user from bumping or scratching themselves on a threaded shank of the tow ball. In one embodiment the skirt walls extend below the tow ball mount about 5 to 35 mm.

In one embodiment the Skirt is open at a rear portion so that there is no front wall of the skirt, so as to facilitate installation on the tow ball mount.

In one embodiment the bumper and skirt walls include radiused edges at junctions between adjacent ones so that impact from body parts such as shins may be reduced. In one embodiment the bumper is a single bumper element extending along all three skirt walls.

In one embodiment the tow ball cover includes retaining ribs to locate and/or grip the tow ball mount on and/or under its sides, the arrangement providing a small space between the head and the tow ball when the tow ball cover is in an installed position on the tow ball mount. The arrangement reduces wear on the tow ball and provides the head portion with some resilience so that it may slightly move when bumped by a shin, to reduce impact damage to the shin and the head portion.

In one embodiment the head portion includes a plurality of spaced-apart walls. In one embodiment the plurality of spaced-apart walls are arranged in a generally frusto-pyramidal form so as to deflect impacts. The walls may be arranged in other suitable ways to reduce impacts, such as frusto-conical, cylindrical, domed, and/or include radiused edges between adjacent walls and tops to deflect impacts and spread them over a wider area to reduce harm.

In one embodiment the head portion includes a leaf spring disposed inside the spaced-apart walls. In one embodiment the leaf spring is mounted in the tow ball cover so that the ends of the leaf spring are connected to the tow ball cover at about the head/base junction on an inside of the housing. The leaf spring generally extends along or around the inside walls of the head portion, spaced a small distance therefrom. The leaf spring includes a shape, such as for example, a steepled head, and straight sides, which can flex to grip the towball when the towball is inserted into the housing.

The leaf spring extends along and from the wall such that that the towball may slightly deform the leaf spring for secure retention when the cover is on the towball.

In one embodiment the head portion includes a strengthening shoulder or rib to strengthen one or more walls of the housing. In one embodiment the strengthening shoulder or rib extends across at least one wall generally from one corner to the other so as to provide a grip to a user when installing the tow ball cover onto the tow ball. The shoulder or rib also provides visual interest and a streamlined shape to the housing.

In one embodiment the strengthening shoulder or rib may form a boundary where two differing materials meet. The two differing materials may be clear/opaque, or elastic/brittle and like combinations. For example a front portion may be clear so that the presence or otherwise of a tow ball can be immediately discerned whereas the rear portion may be opaque for increased protection. Similarly any one or more base regions, or walls of the base portion may be translucent so that light may pass through, the light being generated by an LED apparatus mounted inside the tow ball cover or mounted inside one of the walls of the skirt.

In one embodiment the tow ball cover is a single unitary piece of injection moulded or 30 printed material. In one embodiment the tow ball cover is plastic so as to be flexible in selected parts to reduce impact to shins or other body parts which may come into contact with the tow ball cover.

In one embodiment the tow ball cover is hollow and open at the bottom of the base portion so as to facilitate installation over the tow ball and tow ball mount.

In yet another aspect, the present technology provides a tow ball cover, comprising:
a hollow head portion configured to cover a tow ball, the hollow head portion including opposed generally flat walls to facilitate application of a label or other surface treatment for messaging.

In still another aspect, the present technology provides a unitary tow ball and tow ball mount cover, including:
a hollow base portion configured lo cover a tow ball mount; and
a hollow head portion configured to cover a tow ball, the hollow head portion including opposed generally flat walls to facilitate application of a label or other surface treatment for messaging;
wherein the hollow base portion and the hollow head portion form a junction at a top of the base portion and a foot of the head portion to form a unitary cover.

In this specification, where a document, act or item of knowledge is referred to or discussed, this reference or discussion is not an admission that the document, act or item of knowledge or any combination thereof was at the priority date:
(a) part of common general knowledge; or
(b) known to be relevant to an attempt to solve any problem with which this specification is concerned.

It is to be noted that, throughout the description and claims of this specification, the word ‘comprise’ and variations of the word, such as ‘comprising’ and ‘comprises’, is not intended lo exclude other variants or additional components, integers or steps.

In order that the present technology may be more clearly understood, preferred embodiments will be described with reference to the following drawings and examples

### BRIEF DESCRIPTION OF THE DRAWINGS

In order to enable a clearer understanding, a preferred embodiment of the technology will now be further explained and illustrated by reference to the accompanying drawings, in which:

FIG. 1 is an isometric view from above and one side of a tow ball cover in accordance with a preferred embodiment of the present technology;

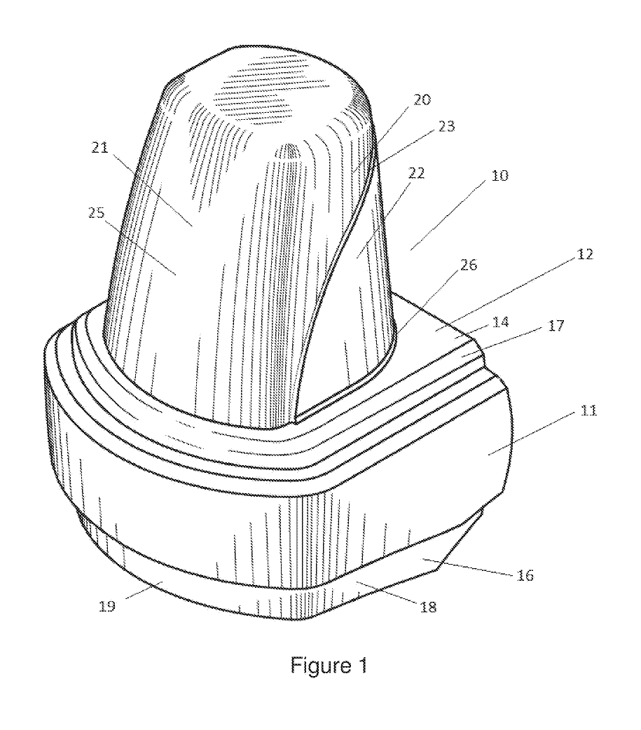

FIG. 2 is a rear elevation view of the tow ball cover shown in FIG. 1;

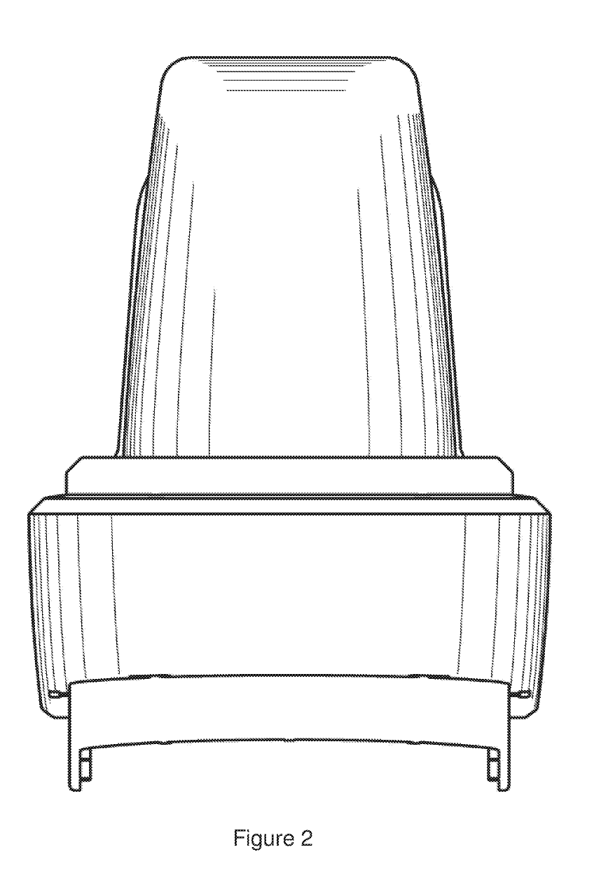

FIG. 3 is a plan view of the tow ball cover shown in FIG. 1:

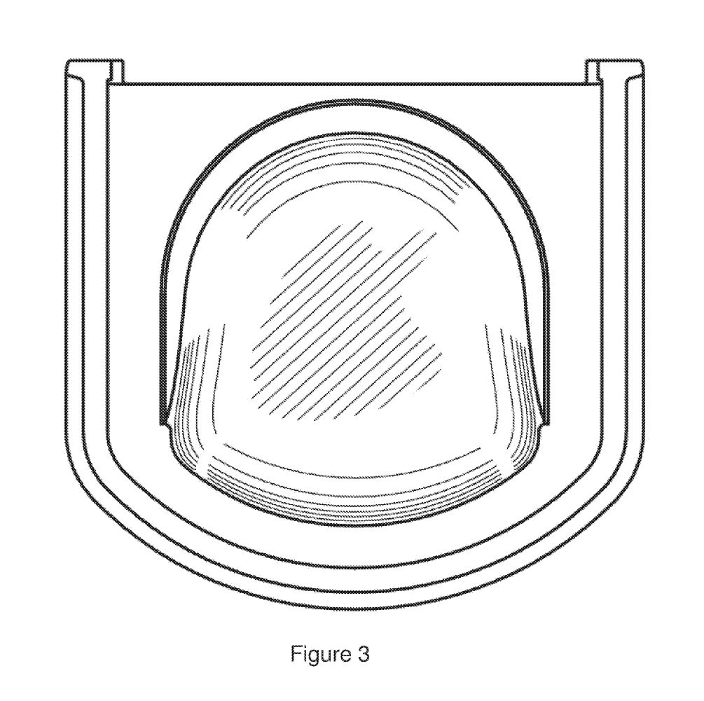

FIG. 4 is a side elevation view of the tow ball cover shown in FIG. 1;

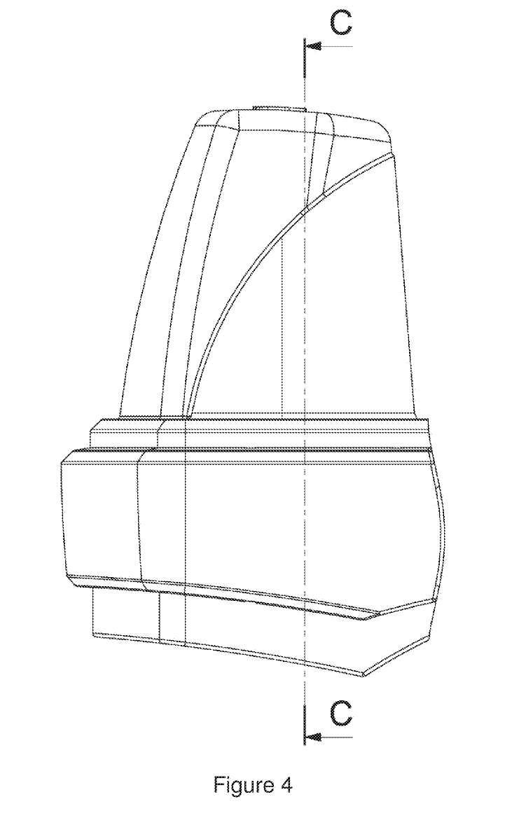

FIG. 5 is a front elevation view of the tow ball cover shown in FIG. 1;

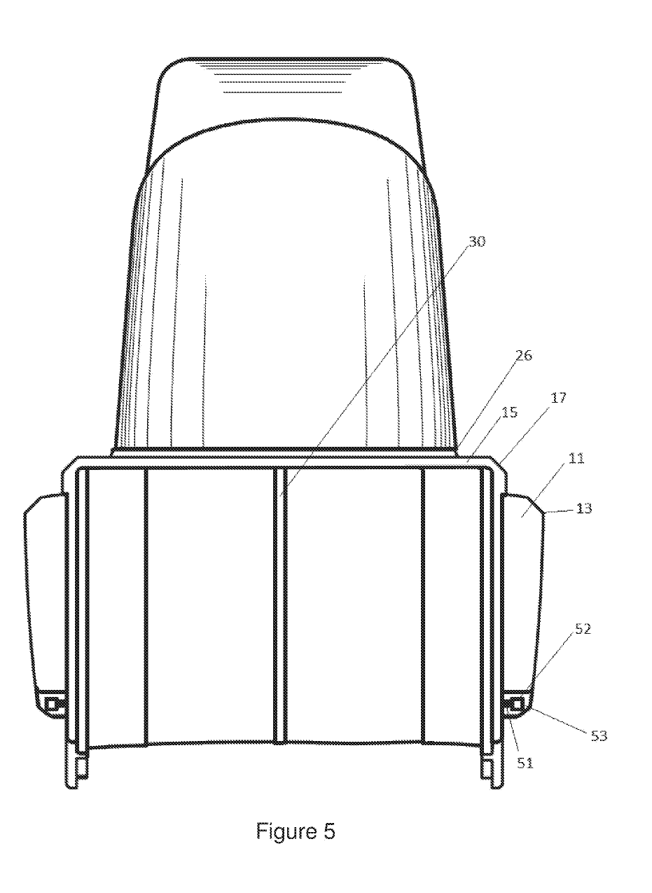

FIG. 6 is a side elevation view of the tow ball cover from the side opposite to that shown in FIG. 4;

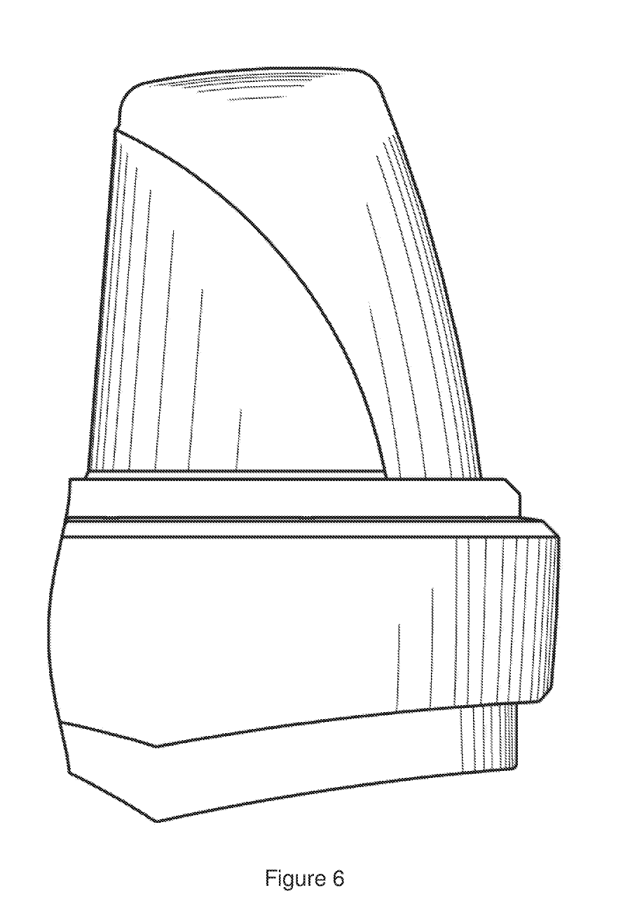

FIG. 7 is a plan view from underneath of the tow ball cover;

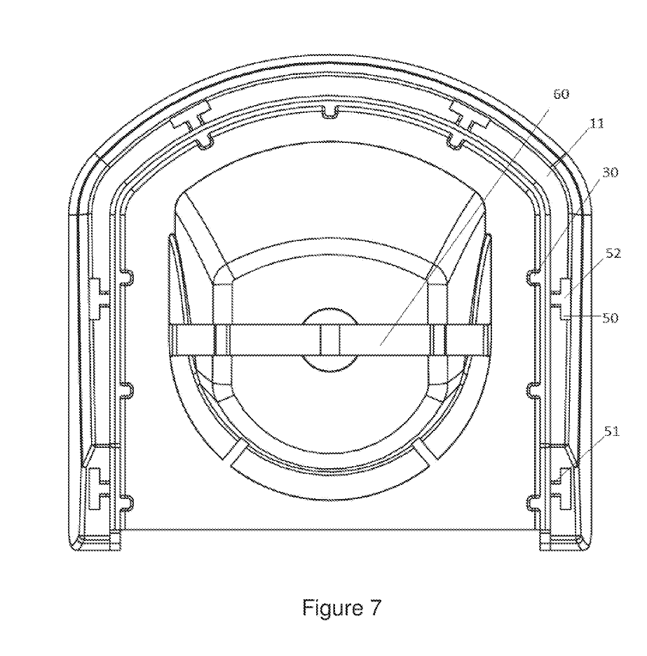

FIG. 8 is a front elevation section view through C-C shown in FIG. 4; and

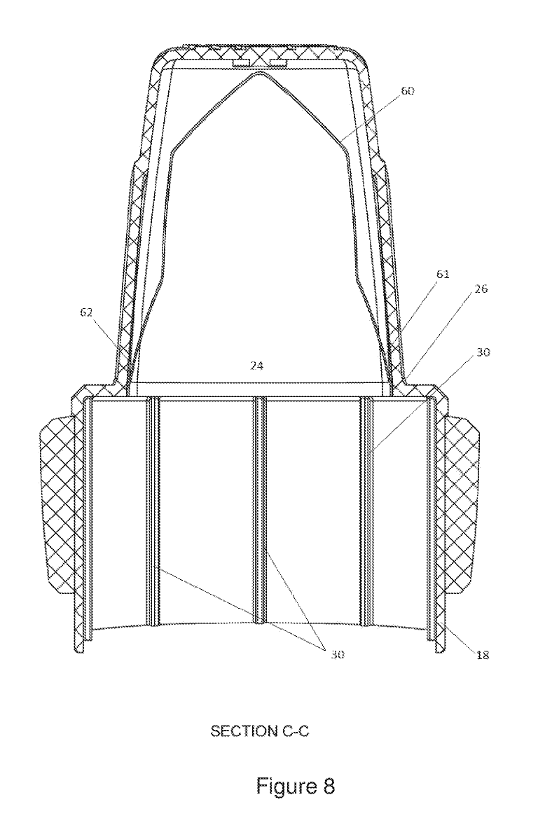

FIG. 9 is an isometric view of a cover with a recess for an insert.

### DETAILED DESCRIPTION OF AN EXAMPLE EMBODIMENT

Referring to the drawings there is shown a tow ball and tow ball mount cover generally indicated at 10, the tow ball and tow ball mount cover 10 being a unitary cover, that is to say, advantageously and conveniently being formed in one piece. The tow ball and tow ball mount cover 10 is a unitary cover configured to cover both a tow ball (not shown) and a tow ball mount (not shown).

The tow ball cover 10 includes a hollow base portion 12 which is configured to cover the tow ball mount, the base portion 12 comprising a deck 14 and a skirt 16 depending from the deck, the hollow base portion 12 being open at a bottom of the base and a rear of the skirt 16 to facilitate installation on the tow ball mount into an installed position on the tow ball mount wherein the deck generally sits on a top face of the tow ball mount.

The tow ball cover 10 also includes a hollow head portion 20 configured to cover the tow ball, the hollow head portion 20 including a tow ball receiving housing 22 being open at a foot end 24 to facilitate loading of the tow ball into the tow ball receiving 22 housing during installation of the tow ball cover 10 into the installed position.

The arrangement of the tow ball housing 10 is such that the base portion 12 and the head portion 20 are integrally connected at a junction 26 between the foot end 24 of the head portion 20 and the deck 14.

The deck 14 may be an any suitable shape or form, being domed or flat, or irregularly-finished on a top surface, so as to strengthen it or for aesthetic appeal. In the embodiment shown the deck is substantially a flange 16 extending from the junction 26 to the skirt 16. The deck 14 also includes a beveled edge 17 extending around the skirt 16 for increasing the strength of the deck 14 and its edge, and reducing impact damage in the event of shin contact.

The skirt 16 includes a plurality of skirt walls 18 generally orthogonal to one another to generally follow the contour of the tow ball mount edges. In one embodiment there are provided three skirt walls 18, integrally connected to adjacent skirt walls around the hollow base portion 12. A rear wall 19 is provided generally fiat to provide a flat surface on which advertising messages or brand names may be placed for easy viewing from a following vehicle. The skirt walls 18 generally are orthogonal substantially to correspond with the walls of a tow ball mount plate, except that the side walls extend further past the rear face so as to facilitate the rear wall 19 being flat.

The skirt 16 also includes a bumper 11 mounted thereon, the bumper 11 being proud of each of the skirt walls 18, 19 so as in use to cushion any impact from, say, a shin. The bumper 11 in the embodiment shown is a different material from that which comprises the hollow base portion 12. The bumper 11 shown is silicon rubber but could equally usefully be other impact reducing material such as rubberised polymer or other kinds of rubber. The bumper 11 may have voids so as to increase flexibility and elasticity and to reduce impacts.

The bumper 11 shown is a separate bumper element attached to the skirt 16. The bumper 11 is configured to mount on respective bumper mounts 50 disposed on the skirt walls 18. The bumper mounts 50 include a bumper mount stem 51 and a bumper mount head 52 disposed at an end of the bumper mount stem 51. The bumper 11 includes a plurality of cooperating Dumper mount receivers 53 for receiving the bumper mounts 50. The bumper mount receivers 53 are voids disposed in a base and/or inside wall of the bumper 11.

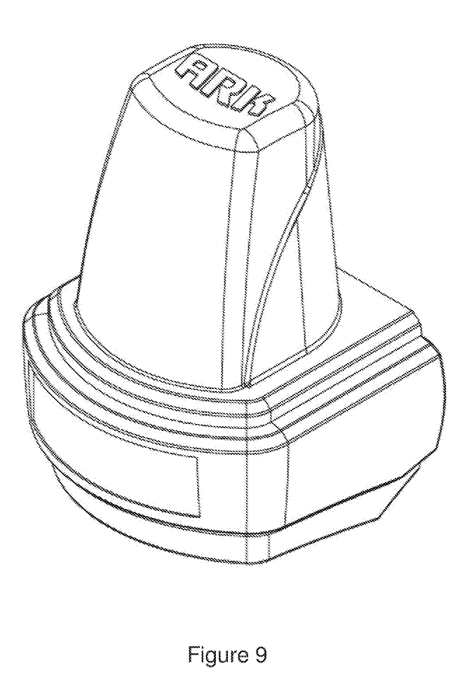

Also shown in FIG. 9 is a recess for locating an insert (not shown) in the form of a plate which includes a message embossed thereon or painted thereon. The insert is located in the recess and kept therein by being overmoulded, riveted, adhered, screwed onto the bumper 11. The advantage of the insert is that it is replaceable and durable, rather than a decal or a painted message onto the bumper, and the insert can be made of a material that is more likely to retain a message thereon, rather than the bumper which is made from rubber or other silicon which may not be able to keep a message thereon.

The insert may be reflective or have a reflective element The insert may be an illuminated panel, and may include a PCB including instructions for illuminating, detecting background light levels and so that it may switch on in the dark, a power source such as a battery, and a light pipe with LEDs disposed at either side so that the panel is illuminated evenly across the panel.

The cover including the skirt and the housing may be vacuum metalized and chrome plated. The cover may be constructed from an engineering plastic such as for example ABS.

One or more of the skirt walls 18 also extend below the tow bat mount so as to protect a user from bumping or scratching themselves on a threaded mounting bar (not shown) of the tow ball. The bumper 11 and skirt walls 18 include radiused edges 17, 13 so that impact from body parts such as shins may be reduced.

The tow ball cover 10 includes retaining ribs 30 to locate and/or grip the tow ball mount on and/or under its sides. The ribs 30 are also useful for stiffening the surface of the skirt walls 18, 19 to reduce undulations during moulding.

The tow ball receiving housing 22 of the head portion 20 includes a plurality of spaced-apart walls 21, The plurality of spaced-apart walls 21 are generally in opposed pairs, orthogonally arranged, so that the tow ball receiving housing 22 forms a square block. Some of the walls are slightly angled to the vertical such the housing 22 is frusto-pyramidal so as to deflect impacts. A top face of the head portion 20 is horizontal to provide a stable face for a label or logo and so that it can be easily read. The arrangement of the walls may be other suitable arrangements to reduce impacts, such as frusto-conical, cylindrical, domed and the like, but these would not have the advantage of providing a stable base for the logo, messaging or labels. The walls 21 include radiused edges to deflect impacts and spread them over a wider area to reduce harm.

Similarly, one rear wall 25 of the housing 22 has a flat face so as to provide a stable face for label, messaging, logos or other suitable messages to allow them to securely affix and to be easily read.

The head portion 20 also includes a leaf spring 60 disposed inside the spaced-apart walls. The leaf spring 60 is mounted in the tow ball cover 10 so that the ends of the leaf spring 61, 62 are connected to the tow ball cover 10 at about the head/base junction 26 on an inside of the housing 22. The leaf spring generally extends upward from the junction 26, following the contour of the inside wails of the head portion, spaced a small distance therefrom. The leaf spring has a steepled or triangular head and straight sides no that they can flex when the tow ball is placed inside the towball receiving housing 22, for increased grip. The leaf spring outline is sized slightly smaller than the tow ball dimension so that the tow ball may slightly deform the leaf spring for secure retention when the cover is on the tow ball.

The head portion 20 includes a strengthening shoulder 23 to strengthen one or more walls 21 of the two ball receiving housing 22. The strengthening shoulder 23 extends across the side walls generally from a rear corner to the upper front corner so as to provide a grip shelf to a user when installing the tow ball cover onto the tow ball.

Advantageously, to reduce costs and to simplify handling the tow ball cover 10 is a single unitary piece of injection moulded or 30 printed material. The tow ball cover 10 is plastic so as to be flexible in selected parts to reduce impact to shins or other body parts which may come into contact with the tow ball cover.

Advantageously the cover 10 reduces wear on the tow ball since the head is part of a base that Cannot move when in an installed position, since the base is in turn located on a tow ball mount plate.

Advantageously the cover 10 reduces the likelihood of, and damage from, contact with a threaded tow ball shank by having a skirt which provides early warning of the tow ball shank proximity.

Advantageously the cover 10 provides a flat screen or surface for advertising or other messaging on the rear wall of the base, being the tow ball mount cover, without limiting the function of the cover. The messaging may be painted, embossed, drawn, or adhered to the bumper 11 which is mounted on the rear wall 19.

One embodiment of the cover 10 is arranged such that the cover looks like a miniature version of the car to Which it is attached, having a saloon and a car body, and a surrounding bumper.

To apply the cover 10 to the tow ball and tow ball mount, the cover 10 is plated over the tow ball and tow ball mount and pressed downwards until the deck 14 generally abuts the tow ball mount plate.

Modifications and improvements to the invention will be readily apparent to those skilled in the art. Such modifications and improvements are intended to be within the scope of this invention.

1. A unitary tow ball and tow ball mount cover, including:
A hollow base portion configured to cover a tow ball mount;
and a hollow head portion configured to cover a tow ball;
wherein the hollow base portion and the hollow head portion form a junction at a top of the base portion and a foot of the head portion to form a unitary cover.

2. A unitary tow ball and tow ball mount cover including:
a base portion configured to cover a tow ball mount, the base cover portion comprising a deck and a skirt depending therefrom;
a head portion configured to cover a tow ball, the head portion comprising a tow ball receiving housing being open at a foot end;
wherein the base portion and the head portion are connected at a junction between the foot end of the deck and the head portion.

3. The tow ball cover of claim 2 wherein the skirt has one more walls extending below the tow ball mount so as in an installed position to protect a user from bumping or scratching themselves on the threaded tow ball shank.

4. The tow ball cover of claim 1 wherein the tow ball cover includes a bumper disposed on the skirt to reduce damage from impacts with users working behind or passing behind a vehicle on which the tow ball is mounted.

5. The tow ball cover of claim 1 wherein the head portion or the base portion includes a rearward-facing wall which is generally flat so as to display messaging or advertising to following cars.
